(19) United States
(12) Patent Application Publication
(10) Pub. No.: US 2026/0086185 A1
(43) Pub. Date: Mar. 26, 2026

(54) METHODS AND APPARATUS OF DETERMINING INTEGRITY OF POSITIONING ESTIMATES

(71) Applicant: Lenovo (Beijing) Limited, Beijing (CN)

(72) Inventors: Robin Rajan Thomas, Bad Nauheim (DE); Jie Hu, Beijing (CN); Hyung-Nam Choi, Ottobrunn (DE)

(73) Assignee: Lenovo (Beijing) Limited, Beijing (CN)

(21) Appl. No.: 19/111,367

(22) PCT Filed: Nov. 17, 2022
(86) PCT No.: PCT/CN2022/132604

§ 371 Date: Mar. 13, 2025

(51) Int. Cl. G01S 5/02; H04W 64/00

(52) U.S. Cl. CPC G01S 5/0244; H04W 64/00

(57) ABSTRACT

Methods and apparatus of determining integrity of positioning estimates are disclosed. The apparatus includes a transmitter that transmits a request message to a device for requesting collection of integrity information, wherein the integrity information comprises integrity service parameters and error bound information associated with a type of positioning error: a receiver that receives a response message comprising determined integrity service parameters and error bound information from the device; and a processor that determines an integrity of a positioning estimate according to the response message.

### FIELD

The subject matter disclosed herein relates generally to wireless communication and more particularly relates to, but not limited to, methods and apparatus of determining integrity of positioning estimates.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX, or Rx), Transmit or Transmitter (TX, or Tx), Physical Uplink Shared Channel (PUSCH), Configured Grant (CG), Channel State Information (CSI), Channel State Information Reference Signal (CSI-RS), Frequency Division Multiple Access (FDMA), Index/Identifier (ID), Information Element (IE), Industrial Internet of Things (IIoT), Positioning Reference Signal (PRS), Radio Access Network (RAN), Radio Resource Control (RRC), Reference Signal (RS), Reference Signal Received Power (RSRP), Reference Signal Received Quality (RSRQ), Round Trip Time (RTT), System Frame Number (SFN), System Information Block (SIB), Sidelink (SL), Sounding Reference Signal (SRS), Synchronization Signal Block (SSB), Transmission Reception Point (TRP), Frequency Range 1 (FR1), Frequency Range 2 (FR2), Incremental Redundancy (IR), The interface between the gNB and the 5GCN (NG), Radio Resource Management (RRM), Synchronization Signal (SS), Technical Report (TR), Technical Specification (TS), Universal Terrestrial Radio Access (UTRA), CSI reference signal received power (CSI-RSRP), CSI reference signal received quality (CSI-RSRQ), Evolved Universal Terrestrial Radio Access (E-UTRA), For Further Study (FFS), Global Navigation Satellite System (GNSS), NR Cell Global Identifier (NCGI), node providing E-UTRA user plane and control plane protocol terminations towards the UE, and connected via the NG interface to the 5GC (ng-eNB), NG Radio Access Network (NG-RAN), StandAlone (SA), SS reference signal received power (SS-RSRP), SS reference signal received quality (SS-RSRQ), Universal Terrestrial Radio Access Network (UTRAN), DownLink-Positioning Reference Signal (DL-PRS), Non Line of Sight (NLOS), Line of Sight (LOS), Dynamic-Grant (DG), Alert Limit (AL), Access Point (AP), Angle-of-Arrival (AoA), Absolute Radio Frequency Channel Number (ARFCN), Antenna Reference Point (ARP), Cell-ID (positioning method) (CID), Angle of Departure (AoD), Time Difference of Arrival (TDOA), Do Not Use (DNU), Enhanced Cell-ID (positioning method) (E CID), Global Positioning System (GPS), Inertial Measurement Unit (IMU), Interface Specification (IS), Location Management Function (LMF), LTE Positioning Protocol (LPP), Metropolitan Beacon System (MBS), Multiple-Round Trip Time (Multi-RTT), NR Positioning Protocol Annex (NRPPa), Observed Time Difference Of Arrival (OTDOA), Protection Level (PL), Reference Signal Time Difference (RSTD), Space Based Augmentation System (SBAS), Time to Alert (TTA), Terrestrial Beacon System (TBS), Target Integrity Risk (TIR), Location Service (LCS), Relative Time Of Arrival (RTOA), Reference Signal Received Path Power (RSRPP).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmission Reception Points) are studied. A TRP is an apparatus to transmit and receive signals, and is controlled by a gNB through the backhaul between the gNB and the TRP.

Integrity methods refer to the measure of trust and associated procedures that ensure the estimated position calculated by the positioning calculation entity can be trustable with a high degree of certainty. The positioning calculation entity may, for example, include the LMF (location server) for UE-assisted positioning methods, or the target-UE for UE-based positioning methods.

In Release 17 of 3GPP specifications, UE based GNSS integrity was introduced. It allows the UE to determine and report to the location server the integrity results of the calculated position which is determined using GNSS positioning methods. In Release 18, a Study Item Description (SID) was approved to study RAT-dependent integrity methods, which measure the trust of a UE's position estimate computed using positioning techniques such as DL-TDoA, DL-AOD, Multi-RTT. UL-TDoA and UL-AoA.

A key starting point is to identify the error sources that contribute to the inaccuracy of certain RAT-dependent positioning methods, which may affect the integrity of the final positioning estimate. Upon identification of the error sources, suitable procedures and signalling may be developed to notify a Location Service (LCS) client when such methods do not fulfil the conditions for the intended positioning operation.

### SUMMARY

Methods and apparatus of determining integrity of positioning estimates are disclosed.

According to a first aspect, there is provided an apparatus, including: a transmitter that transmits a request message to a device for requesting collection of integrity information, wherein the integrity information comprises integrity service parameters and error bound information associated with a type of positioning error; a receiver that receives a response message comprising determined integrity service parameters and error bound information from the device; and a processor that determines an integrity of a positioning estimate according to the response message.

According to a second aspect, there is provided an apparatus, including: a receiver that receives a request message from a device requesting collection of integrity information, wherein the integrity information comprises integrity service parameters and error bound information associated with a type of positioning error; a processor that determines, in response to the request message, a response message comprising the integrity service parameters and the error bound information; and a transmitter that transmits the response message to the location server for determining an integrity of a positioning estimate.

According to a third aspect, there is provided a method, including: transmitting, by a transmitter, a request message to a device for requesting collection of integrity information, wherein the integrity information comprises integrity service parameters and error bound information associated with a type of positioning error; receiving, by a receiver, a response message comprising determined integrity service parameters and error bound information from the device; and determining, by a processor, an integrity of a positioning estimate according to the response message.

According to a fourth aspect, there is provided a method, including: receiving, by a receiver, a request message from a device requesting collection of integrity information, wherein the integrity information comprises integrity service parameters and error bound information associated with a type of positioning error; determining, by a processor, in response to the request message, a response message comprising the integrity service parameters and the error bound information; and transmitting, by a transmitter, the response message to the location server for determining an integrity of a positioning estimate.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4A is a schematic diagram illustrating an example of NR beam-based positioning in accordance with some implementations of the present disclosure;

FIG. 4B is a schematic diagram illustrating an example of Multi-cell RTT procedure in accordance with some implementations of the present disclosure;

FIG. 4C is a schematic diagram illustrating an example of relative range estimation using existing single gNB RTT positioning framework in accordance with some implementations of the present disclosure;

FIG. 5A is a schematic diagram illustrating an example of enabling collection of DL-based measurement error bound information and associated integrity service parameters via request/response signalling in accordance with some implementations of the present disclosure:

FIG. 5B is a schematic diagram illustrating an example of enabling collection of UL-based measurement error bound information and associated integrity service parameters via request/response signalling in accordance with some implementations of the present disclosure;

FIG. 6A is a schematic diagram illustrating an example of enabling collection of assistance data error bound information and associated integrity service parameters via LMF-UE request/response signalling in accordance with some implementations of the present disclosure;

FIG. 6B is a schematic diagram illustrating an example of enabling collection of assistance data error bound information and associated integrity service parameters via LMF-NG-RAN node request/response signalling in accordance with some implementations of the present disclosure;

FIG. 7 is a flow chart illustrating steps of determining integrity of positioning estimates by UE or LMF in accordance with some implementations of the present disclosure; and

FIG. 8 is a flow chart illustrating steps of determining integrity of positioning estimates by UE or gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment.” “an example,” “some embodiments.” “some examples.” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

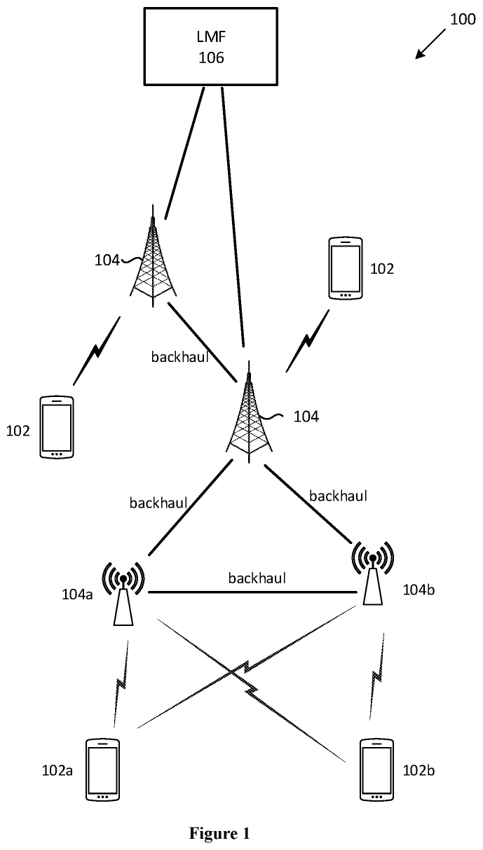

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP”, “Transmission Reception Point”, and “transmitting-receiving identity” may be used interchangeably throughout the disclosure.

The core network includes a location server, or Location Management Function (LMF) 106. The LMF 106 in the core network may be implemented as a hardware component, a software program or module, or a combination of hardware and software. The base station or gNB 104 may be communicably coupled to the LMF106 of the core network through wired or wireless communication links.

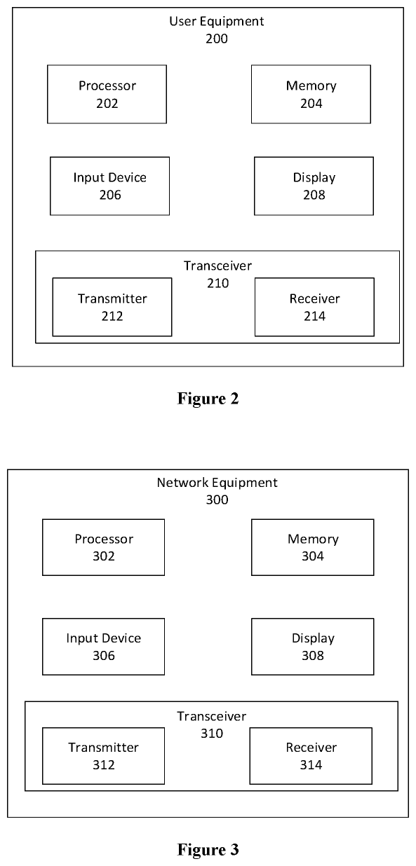

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

This disclosure presents systems, apparatuses and methods for enhanced RAT-dependent integrity, as well as procedures to enable reliable and trustworthy Uu (uplink or downlink) positioning.

Designs of framework and procedures are proposed to support integrity service parameters and error bound information exchange amongst UE, base station and location server, which may also be referred to as Location Management Function (LMF), in order to ensure reliable RAT-dependent positioning integrity.

Based on the type of positioning error and integrity mode of operation, i.e., LMF-based or UE-based integrity, the type of integrity service parameters and error bound information may vary accordingly. These parameters may then be utilized to determine the positioning integrity of computed positioning estimates based on one or more RAT-dependent positioning techniques.

NR positioning based on NR Uu signals and Standalone (SA) architecture (e.g., beam-based transmissions) was first specified in Release 16. The targeted use cases also included commercial and regulatory (i.e., emergency services) scenarios as in Release 15. The performance requirements are provided in the following Table 1 [3GPP Technical Report TR 38.855]:

TABLE 1
Release 16 Positioning Performance Requirements

| Positioning Error | Indoor | Outdoor |
|---|---|---|
| Horizontal | <3 m for 80% of | <10 m for 80% of |
| Positioning | UEs | UEs |
| Vertical Positioning | <3 m for 80% of | <3 m for 80% of UEs |
| | UEs | |

Current 3GPP Release 17 has recently defined the positioning performance requirements for Commercial and IIoT use cases as follows, in Table 2 [3GPP Technical Report TR 38.857]:

TABLE 2
Release 17 Positioning Performance Requirements

| Positioning Error | Commercial | IIoT |
|---|---|---|
| Horizontal Positioning | (<1 m) for 90% of | (<0.2 m) for 90% of |
| | UEs | UEs; |
| Vertical Positioning | (<3 m) for 90% of | (<1 m) for 90% of |
| | UEs | UEs |
| Physical layer latency | (<10 ms) | (<10 ms) |
| for position estimation | | |
| of UE | | |
| End-to-End Latency | (<100 ms) | (<100 ms, in the order |
| for position estimation | | of 10 ms is desired) |
| of UE | | |

The supported positioning techniques in Release 16 are listed in Table 3 [3GPP Technical Specification TS 38.305]

TABLE 3
Supported UE Positioning Methods in Release 16

| | | UE- | | |
|---|---|---|---|---|
| | UE- | assisted, | NG-RAN | |
| Method | based | LMF-based | node assisted | SUPL |
| A-GNSS | Yes | Yes | No | Yes (UE-based and |
| | | | | UE-assisted) |
| OTDOA ^{Note 1,} | No | Yes | No | Yes (UE-assisted) |
| ^{Note 2} | | | | |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | Nc | Yes | Yes | No |
| NR E-CID | No | Yes | FFS | No |
| UL-TDOA | No | No | Yes | No |
| UL-AoA | No | No | Yes | No |

^{Note 1}
This includes TBS positioning based on PRS signals.
^{Note 2}
In this version of the specification only OTDOA based on LTE signals is supported.
^{Note 4}
This includes Cell-ID for NR method.
^{Note 5}
In this version of the specification only for TBS positioning based on MBS signals.

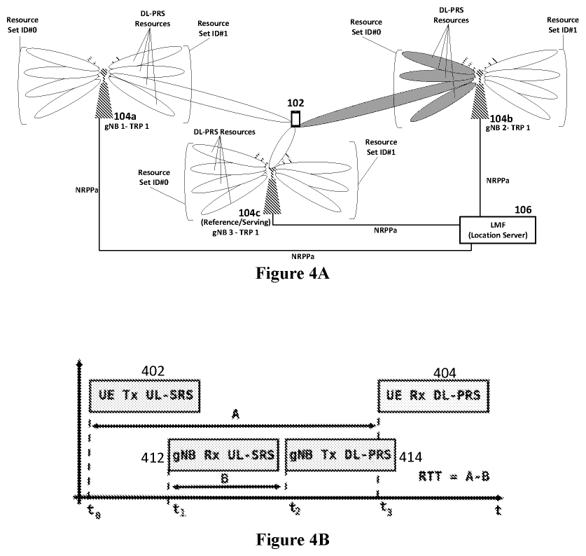

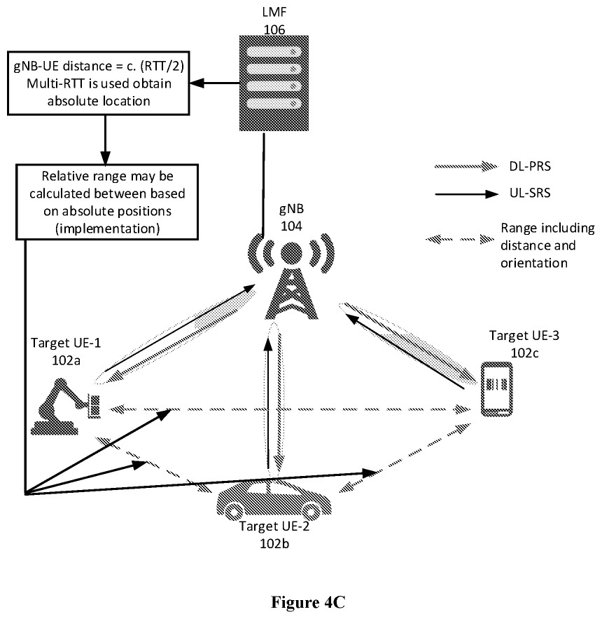

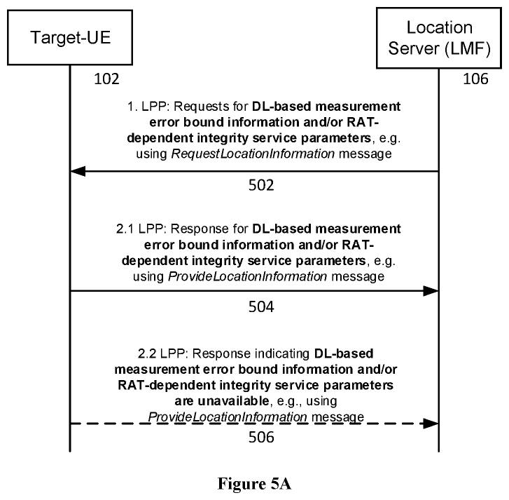

Separate positioning techniques as indicated in Table 3 may be dynamically configured and performed based on the requirements of the LMF and UE capabilities. The transmission of Uu (uplink and downlink) Positioning Reference Signals (PRS) enables a UE to perform UE positioning-related measurements or a gNB to perform gNB positioning-related measurements to enable the computation of the UE's absolute location estimate and is configured per Transmission Reception Point (TRP), where a TRP may include a set of one or more beams. A conceptual overview is illustrated in FIG. 4A, which is a schematic diagram illustrating an example of NR beam-based downlink positioning in accordance with some implementations of the present disclosure.

According to Release 16, the PRS may be transmitted by different base stations (e.g., serving and neighboring base stations) using narrow beams over FR1 and FR2 as illustrated in FIG. 4A, which is relatively different compared to LTE where the PRS was transmitted across the whole cell.

In the example shown in FIG. 4A, the LMF 106 is in communication with three gNBs, each in turn communicates with the UE 102 through a respective TRP, i.e., TRP1 of gNB1 104a, TRP1 of gNB2 104b, and TRP1 or gNB3 104c. The PRS can be locally associated with a PRS Resource ID and Resource Set ID for a base station (gNB or TRP). Similarly, UE positioning measurements such as Reference Signal Time Difference (RSTD) and PRS RSRP measurements are made between beams (e.g., between a different pair of DL PRS resources or DL PRS resource sets) as opposed to different cells in the case of LTE. In addition, there are additional UL positioning methods for the network to exploit in order to compute the target UE's location. Table 4 and Table 5 below show the reference signal to measurements mapping required for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, IMU sensor, WLAN and Bluetooth technologies for performing target device (i.e., UE) positioning.

TABLE 4
UE Measurements to Enable RAT-dependent Positioning Techniques

| | | To facilitate support of the |
|---|---|---|
| | | following positioning |
| DL/UL Reference Signals | UE Measurements | techniques |
| Release 16 DL PRS | DL RSTD | DL-TDOA |
| Release 16 DL PRS | DL PRS RSRP | DL-TDOA, DL-AOD, |
| | | Multi-RTT |
| Release 16 DL PRS/ | UE Rx-Tx time | Multi-RTT |
| Release 16 SRS for | difference | |
| positioning | | |
| Release 15 SSB/CSI- | SS-RSRP(RSRP for | E-CID |
| RS for RRM | RRM), SS-RSRQ(for | |
| | RRM), CSI-RSRP (for | |
| | RRM), CSI-RSRQ (for | |
| | RRM), SS-RSRPB | |
| | (for RRM) | |

TABLE 5
gNB Measurements to Enable RAT-
dependent Positioning Techniques

| | | To facilitate |
|---|---|---|
| | | support of the |
| DL/UL | | following positioning |
| Reference Signals | gNB Measurements | techniques |
| Release 16 SRS for | UL RTOA | UL-TDOA |
| positioning | | |
| Release 16 SRS for | UL SRS-RSRP | UL-TDOA, UL-AoA, |
| positioning | | Multi-RTT |
| Release 16 SRS for | gNB Rx-Tx time | Multi-RTT |
| positioning, Release | difference | |
| 16 DL PRS | | |
| Release 16 SRS for | AoA and ZoA | UL-AoA, Multi-RTT |
| positioning, | | |

The following RAT-dependent positioning techniques are supported in Release 16 and Release 17 [3GPP Technical Specification TS 38.305]:

### DL-TDOA

The DL-TDOA positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

### DL-AOD

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

### Multi-RTT

The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.
The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server, which are used to estimate the location of the UE as shown in FIG. 4B.
FIG. 4B is a schematic diagram illustrating an example of Multi-cell RTT procedure in accordance with some implementations of the present disclosure. In this example, the Round Trip Time. RTT equals to =A-B, where A is the period from the starting of the transmission of UL-SRS 402 at the UE to the starting of the reception of DL-RPS 404 at the UE, and B is the period from the starting of reception of UL-SRS 412 at the gNB to the starting of the transmission of DL-PRS 414 at the gNB. It is noted that Multi-RTT is only supported for UE-assisted/NG-RAN assisted positioning techniques as shown in Table 3.
FIG. 4C is a schematic diagram illustrating an example of relative range estimation using the existing single gNB RTT positioning framework in accordance with some implementations of the present disclosure. FIG. 4C illustrates an implementation-based approach to compute the relative distance between two UEs. In FIG. 4C, the LMF 106 is in communication with the gNB 104, which communicates with three target UEs 102a, 102b, 102c. Multi-RTT is used to obtain the absolute locations of the UEs, and the relative range (i.e., the relative distance) between two UEs may be calculated based on absolute positions. This approach is high in latency and is not an efficient method in terms of procedures and signalling overhead.

### E-CID/NR E-CID

Enhanced Cell ID (CID) positioning method, the position of an UE is estimated with the knowledge of its serving ng-eNB, gNB and cell and is based on LTE signals. The information about the serving ng-eNB, gNB and cell may be obtained by paging, registration, or other methods. NR Enhanced Cell ID (NR E CID) positioning refers to techniques which use additional UE measurements and/or NR radio resource and other measurements to improve the UE location estimate using NR signals.
Although NR E-CID positioning may utilize some of the same measurements as the measurement control system in the RRC protocol, the UE generally is not expected to make additional measurements for the sole purpose of positioning; i.e., the positioning procedures do not supply a measurement configuration or measurement control message, and the UE reports the measurements that it has available rather than being required to take additional measurement actions.

### UL-TDOA

The UL TDOA positioning method makes use of the UL RTOA (and optionally UL SRS-RSRP) at multiple RPs of uplink signals transmitted from UE. The RPs measure the UL RTOA (and optionally UL SRS-RSRP) of the received signals using assistance data received from the positioning server, and the resulting measurements are used along with other configuration information to estimate the location of the UE.

### UL-AoA

The UL AoA positioning method makes use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

The following RAT-independent positioning techniques are also supported in Release 16 and Release 17 [3GPP Technical Specification TS 38.305]:

Network-assisted GNSS methods
These methods make use of UEs that are equipped with radio receivers capable of receiving GNSS signals. In 3GPP specifications the term GNSS encompasses both global and regional/augmentation navigation satellite systems.
Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services.
In this concept, different GNSSs (e.g., GPS. Galileo, etc.) can be used separately or in combination to determine the location of a UE.

### Barometric Pressure Sensor Positioning

The barometric pressure sensor method makes use of barometric sensors to determine the vertical component of the position of the UE. The UE measures barometric pressure, optionally aided by assistance data, to calculate the vertical component of its location or to send measurements to the positioning server for position calculation.
This method should be combined with other positioning methods to determine the 3D position of the UE.

### WLAN Positioning

The WLAN positioning method makes use of the WLAN measurements (AP identifiers and optionally other measurements) and databases to determine the location of the UE. The UE measures received signals from WLAN [1] access points, optionally aided by assistance data, to send measurements to the positioning server for position calculation. Using the measurement results and a references database, the location of the UE is calculated.
Alternatively, the UE makes use of WLAN measurements and optionally WLAN AP assistance data provided by the positioning server, to determine its location.

### Bluetooth Positioning

The Bluetooth positioning method makes use of Bluetooth measurements (beacon identifiers and optionally other measurements) to determine the location of the UE. The UE measures received signals from Bluetooth [2] beacons. Using the measurement results and a references database, the location of the UE is calculated. The Bluetooth methods may be combined with other positioning methods (e.g., WLAN) to improve positioning accuracy of the UE.

### TBS Positioning

A Terrestrial Beacon System (TBS) consists of a network of ground-based transmitters, broadcasting signals only for positioning purposes. The current type of TBS positioning signals are the MBS (Metropolitan Beacon System) signals [3] and Positioning Reference Signals (PRS) (TS 36.211 [4]). The UE measures received TBS signals, optionally aided by assistance data, to calculate its location or to send measurements to the positioning server for position calculation.

### Motion Sensor Positioning

The motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method should be used with other positioning methods for hybrid positioning.

The different DL measurements including DL PRS-RSRP, DL RSTD and UE Rx-Tx time difference required for the supported RAT-dependent positioning techniques are shown in Table 6. The following measurement configurations are specified [3GPP Technical Specification TS 38.215]:
a) 4 Pair of DL RSTD measurements can be performed per pair of cells. Each measurement is performed between a different pair of DL PRS Resources/Resource Sets with a single reference timing.
b) 8 DL PRS RSRP measurements can be performed on different DL PRS resources from the same cell.

TABLE 6
DL Measurements required for DL-based positioning methods
DL PRS reference signal received power (DL PRS-RSRP)

| | |
|---|---|
| Definition | DL PRS reference signal received power (DL PRS-RSRP), is defined as the |
| | linear average over the power contributions (in [W]) of the resource elements |
| | that carry DL PRS reference signals configured for RSRP measurements |
| | within the considered measurement frequency bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements |
| | corresponding to a given receiver branch. For frequency range 1 and 2, if |
| | receiver diversity is in use by the UE, the reported DL PRS-RSRP value shall |
| | not be lower than the corresponding DL PRS-RSRP of any of the individual |
| | receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node |
| | i, defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one |
| | subframe from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one |
| | subframe of the first arrival path of the positioning node. |
| | For frequency range 1, the reference point for T_{UE-RX} measurement shall be |
| | the Rx antenna connector of the UE and the reference point for T_{UE-RX} |
| | measurement shall be the Tx antenna connector of the UE. For frequency |
| | range 2, the reference point for T_{UE-RX} measurement shall be the Rx antenna |
| | of the UE and the reference point for T_{UE-TX} measurement shall be the Tx |
| | antenna of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS reference signal received path power (DL PRS-RSRPP), is defined |
| | as the power of the linear average of the channel response at the i-th path |
| | delay of the resource elements that carry DL PRS signal configured for the |
| | measurement, where DL PRS-RSRPP for the 1st path delay is the power |
| | contribution corresponding to the first detected path in time. |
| | For frequency range 1, the reference point for the DL PRS-RSRPP shall be |
| | the antenna connector of the UE. For frequency range 2, DL PRS-RSRPP |
| | shall be measured based on the combined signal from antenna elements |
| | corresponding to a given receiver branch. |
| Applicable for | RRC_CONNECTED, |
| | RRC_INACTIVE |

For convenience of description, in the disclosure, the following KPIs for positioning integrity are defined:

Target Integrity Risk (TIR): The probability that the positioning error exceeds the Alert Limit (AL) without warning the user within the required Time-to-Alert (TTA).

It may be noted that, conventionally, the TIR is usually defined as a probability rate per some time unit (e.g., per hour, per second or per independent sample).

Alert Limit (AL): The maximum allowable positioning error such that the positioning system is available for the intended application. If the positioning error is beyond the AL, the positioning system should be declared unavailable for the intended application to prevent loss of positioning integrity.

When the AL bounds the positioning error in the horizontal plane or on the vertical axis, then it is called Horizontal Alert Limit (HAL) or Vertical Alert Limit (VAL), respectively.

Time-to-Alert (TTA): The maximum allowable elapsed time from when the positioning error exceeds the Alert Limit (AL) until the function providing positioning integrity annunciates a corresponding alert.

Integrity Availability: The integrity availability is the percentage of time that the PL is below the required AL.

The Protection Level (PL) is a real-time upper bound on the positioning error at the required degree of confidence, where the degree of confidence is determined by the TIR probability.

The PL is a statistical upper-bound of the Positioning Error (PE) that ensures that, the probability per unit of time of the true error being greater than the AL and the PL being less than or equal to the AL, for longer than the TTA, is less than the required TIR, i.e., the PL satisfies the following inequality:

$$Prob per unit of time [ ( ( PE > AL ) \& ( PL <= AL ) ) for longer than TTA ] < required TIR$$

It may be noted that when the PL bounds the positioning error in the horizontal plane or on the vertical axis, then it is called Horizontal Protection Level (HPL) or Vertical Protection Level (VPL) respectively. A specific equation for the PL may not be specified as this is implementation-defined. For the PL to be considered valid, it must simply satisfy the inequality above.

The PL is used to indicate the positioning system availability, as when the PL is greater than the AL, the system is considered unavailable. The PL establishes a more rigorous upper bound on the positioning error by taking into consideration the additional feared events which have a lower occurrence (i.e., lower TIR) compared to the nominal events considered in the standard accuracy estimate alone. The lower the TIR, the more feared events need to be considered.

Fault feared events are those which are intrinsic to the positioning system and typically caused by the malfunction of an element of the positioning system (e.g., constellation or ground network failures). Fault-free feared events occur when the positioning system inputs are erroneous, but the event is not caused by a malfunction of the positioning system. In the GNSS context for example, fault-free feared events include nominal effects experienced every day such as poor satellite geometry, larger atmospheric gradients, and signal interruption, all of which can degrade positioning performance without causing the system to fail. A common limitation of existing industry functional safety standards is that only the fault conditions are considered. In practice, however, the fault-free conditions also have a material contribution to the total integrity risk budget and must therefore be monitored.

The PL is necessary to ensure all potential faults and fault-free events down to the required TIR are considered. It bounds the tails of the distribution with higher certainty (per unit of time) and provides a measure for ensuring only those positions whose positioning integrity has been validated within the TIR are included in the final positioning solution. By contrast, the standard accuracy estimate only considers a subset of feared events up to a nominal percentile (e.g., 2-sigma, 95%), based on the entire distribution of estimated position errors.

The TIR is a design constraint for a positioning system and represents the probability that a positioning error exceeds the AL, but the positioning system fails to alert the user within the required period of time (i.e., TTA). In practice, the TIR is very small. For example, <10⁻⁷/hr TIR translates to one failure permitted every 10 million hours (equivalent to 1142 years approximately).

Positioning integrity system failures are known as Integrity Events and integrity events occur when the positioning system outputs Hazardous Misleading Information (HMI). HMI occurs when, the positioning being declared available, the actual positioning error exceeds the AL without annunciating an alert within the required TTA. Misleading Information (MI) occurs when, the positioning system being declared available, the actual positioning error exceeds the PL. Typically, positioning systems are designed to tolerate some level of MI, provided the system can continue to operate safely within the AL. To properly monitor for integrity in the positioning system, both the fault and fault-free conditions which potentially lead to MI or HMI need to be characterized for the network and the UE.

In the present disclosure, methods and apparatus of determining integrity of positioning estimates are proposed for enabling integrity for RAT-dependent positioning methods.

In some examples, there is provide a scheme to enable procedures of collection of integrity service parameters and associated error bound information for RAT-dependent positioning methods based on the list of error sources that may contribute to feared events, which may be supported for LMF-based and UE-based Integrity computations.

In some examples, there is provide a scheme to enable efficient request and response signalling of RAT-dependent integrity service parameters and error bound information for measurement errors according to the configured positioning method.

In some examples, there is provide a scheme to enable efficient request and response signalling of RAT-dependent integrity service parameters and error bound information for assistance data errors according to the configured positioning method.

The above schemes or methods may be implemented separately, or in combination with each other, to support NR RAT-dependent positioning methods over the SL (PC5) interface.

In this disclosure, a positioning-related reference signal may be referred to as a reference signal used for positioning procedures or positioning purposes in order to estimate a target-UE's location, e.g., PRS, or utilizing existing reference signals such as CSI-RS or SRS; and a target-UE may be referred to as the device or entity to be localized or positioned. In various embodiments or examples, the term ‘PRS’ may refer to any signal such as a reference signal, which may or may not be used primarily for positioning.

In this disclosure, any reference made to position or location information may refer to either an absolute position, relative position with respect to another node or entity, ranging in terms of distance, ranging in terms of direction, or the combination thereof.

All contents of the PCT application of the same inventors, titled “METHODS AND APPARATUS OF POSITIONING INTEGRITY COMPUTATION” and filed on the same date as this patent application, are incorporated herein by reference in its entirety, and may be implemented in combination with the embodiments in this disclosure.

### Integrity Service Parameters for RAT-dependent Positioning Methods

In some examples, the procedures to support the signalling exchange of integrity service parameters are proposed for the different RAT-dependent positioning techniques in order for the positioning calculation entity to compute the real-time integrity. The integrity service parameters may comprise at least the integrity risk parameters, which may include the integrity risk lower and upper bounds in order to satisfy the RAT-dependent integrity operation as defined by the following relationship:

$$P ( RAT - dependent Error > Bound for longer than TTA \vert NOT DNU ) <= Residual Risk + IRallocation , \qquad ( 1 )$$

where TTA is the elapsed time for which the RAT-dependent positioning error may be higher than the Alert limit, before an alarm or warning message may be signalled to the positioning calculation entity, which may include the LMF (location server) for UE-assisted positioning methods, or in other implementations, the target-UE for UE-based positioning methods; DNU refers to “Do Not Use” flag; Residual Risk is the probability of Onset, which is defined per unit of time and represents the probability that the feared event occurs, or begins; and IRallocation is defined as a range of integrity risk defined by the abovementioned lower and upper bounds. The feared event is coupled with the anticipated positioning error exceeding a certain configured threshold and arising from a particular error source, which may vary depending on the error source and the applicable positioning technique. In some implementations, separate feared events may be defined for each RAT-dependent integrity error source and may be signalled to the positioning calculation entity depending on the type of positioning model and associated integrity model. Two positioning integrity models are supported for the positioning integrity calculation, including:
a) LMF-based Integrity, where the positioning integrity is computed at the LMF; and
b) UE-based Integrity, where the positioning integrity is computed at the target-UE.

Table 7 is a list of the RAT-dependent integrity error sources, each of which being characterized as either measurement errors or positioning assistance data errors. Measurement errors may be any errors or discrepancies when performing the actual RAT-dependent positioning measurement, and may include errors arising from the type of hardware, capability of the UE or device, software-related errors, and the like.

TABLE 7
RAT-dependent Error Sources with Associated Error Distribution Models

| | Integrity | Positioning | Measurement | Assistance Data | Error |
|---|---|---|---|---|---|
| No. | Mode | method | Error Sources | Error Sources | Distribution |
| A-1 | LMF- | DL-TDOA | RSTD | — | Normal |
| | based | | | | (time units) |
| A-2 | LMF- | UL-TDOA | RTOA | — | Normal |
| | based | | | | (time units) |
| A-3 | LMF- | Multi-RTT | UE Rx-Tx | — | Normal |
| | based | | time | | (time units) |
| | | | difference | | |
| A-4 | LMF- | Multi-RTT | gNB Rx-Tx | — | Normal |
| | based | | time | | (time units) |
| | | | difference | | |
| | | | measurements | | |
| A-5 | LMF- | UL-AoA | AoA/ZoA | — | Normal for LCS |
| | based | | | | and GCS |
| | | | | | (degrees/radians) |
| A-6 | LMF- | DL- | DL-PRS | — | Normal |
| | based | TDoA/DL- | RSRP | | (dB/dBm/power |
| | | AoD/Multi- | DL-PRS | | units) |
| | | RTT | RSRPP | | |
| A-7 | LMF- | DL-TDOA | — | TRP Location | Uniform and/or |
| | based | | | | Normal |
| A-8 | LMF- | DL-AoD | — | TRP Location | Uniform and/or |
| | based | | | | Normal |
| A-9 | LMF- | UL-TDoA | — | TRP Location | Uniform and/or |
| | based | | | | Normal |
| A-10 | LMF- | UL-AoA | — | TRP Location | Uniform and/or |
| | based | | | | Normal |
| A-11 | LMF- | UL-TDOA | — | SFN Initialization | Normal |
| | based | | | Time | (time units) |
| A-12 | LMF- | DL-TDOA | — | SFN Initialization | Normal |
| | based | | | Time | (time units) |
| A-13 | LMF- | Multi-RTT | — | SFN Initialization | Normal |
| | based | | | Time | (time units) |
| A-14 | LMF- | Multi-RTT | — | TRP Location | Uniform and/or |
| | based | | | | Normal |
| A-15 | LMF- | UL-AoA | — | Inter-TRP | Uniform and/or |
| | based | | | Synchronization | Normal |
| A-16 | LMF- | UL-AoA | — | ARP Location | Uniform and/or |
| | based | | | Information | Normal |
| B-1 | UE- | DL-TDoA | RSTD | — | Normal (time |
| | based | | | | units) |
| B-2 | UE- | DL-AoD | DL-PRS | — | Normal |
| | based | | RSRP | | (dB/dBm/power |
| | | | DL-PRS | | units) |
| | | | RSRPP | | |
| B-3 | UE- | DL-TDoA | — | Inter-TRP | Uniform and/or |
| | based | | | Synchronization | Normal |
| B-4 | UE- | DL-TDoA | — | TRP Location | Uniform and/or |
| | based | | | | Normal |
| B-5 | UE | DL-AoD | — | NR-DL-PRS- | Uniform and/or |
| | based | | | BeamInfo | Normal |
| B-6 | UE- | DL-AoD | — | NR-TRP- | Uniform and/or |
| | based | | | BeamAntennaInfo | Normal |

According to a one aspect, IRallocations_{RAT-dependent} defined by irMinimum_{RAT-dependent}<IRallocation_{RAT-dependent}<irMaximum_{RAT-dependent} may be provided for each error source according to LMF-based (A-1 to A-16 in Table 7) or UE-based (B-1 to B-6 in Table 7) integrity modes of operation. The IRallocations_{RAT-dependent} are to be provided by the entity or node from which the error sources may originate, i.e. the node or entity performing the actual measurements, e.g., NG-RAN (gNB) for UL-based positioning measurements or UE for DL-based positioning measurements.

According to a further aspect, the IRallocations_{RAT-dependent} may be signalled as part of the integrity service parameters, which may be signalled per positioning method via Broadcast signalling, e.g., a new positioning system information broadcast message (posSIB) or LPP dedicated (UE-specific) message.

In some implementations, the application layer with the internal or external Location Service (LCS) clients may also define the target integrity risk, e.g., in terms of a probability value that the positioning error is larger than the alert limit without triggering an alarm or warning message based on the computed positioning estimate, which is calculated using RAT-dependent positioning methods, RAT-independent positioning methods, or a combination of RAT-dependent and RAT-independent positioning methods. This may be used to also define the IRallocations_{RAT-dependent}. This may also be provided to the measurement entity, e.g., gNB or UE.

In some implementations, the UE may signal the TIR to the LMF via LPP signalling, e.g., LPP ProvideCapabilityInformation message. ProvideLocationInformation message or the like. In some other implementations, the LMF may signal the TIR received from an external LCS client to the UE via LPP signalling e.g., LPP ProvideAssistanceData message, RequestLocationInformation message or the like.

According to a further aspect, the UE may further request for the RAT-dependent integrity service parameters including IRallocations_{RAT-dependent} per positioning method using LPP signalling. e.g., via LPP RequestAssistanceData message.

According to another aspect, the signalled IRallocations are used to determine the probability that a defined RAT-dependent fault begins or starts based on the associated error source as well as the RAT-dependent integrity bounds characterized by the error distribution of each error source. The probability of onset of a defined RAT-dependent fault is also referred to as the ResidualRisk in relationship (1). The probability of onset of a feared event or an error occurring may be determined at the entity in which the error affecting the integrity computation originates, e.g., UE, gNB or LMF. Each feared event is characterized by MeanDuration which the feared event spans (in time units such as milliseconds, seconds, minutes and so forth). Using the ResidualRisk and MeanDuration, it would be also possible to determine the occurrence of RAT-dependent positioning feared event at a given time based on the following equation:

$$P ( Feared Event is Present ) = Mean Duration * Probability of Onset of Feared Event \qquad ( 2 )$$

The RAT-dependent errors arising from the error sources are to be bounded based on a computed mean and standard deviation of each error source, where the methods for signalling such information depend on the error type, i.e., measurement errors or assistance data errors. This does not preclude other types of error which have been identified, which may affect the integrity computation.

In some implementations, the integrity correlation time and/or probability of onset of a measurement error may be reported to the location server (LMF) using LPP signalling. The integrity correlation time may be defined as the minimum time interval beyond which two sets of RAT-dependent measurement or assistance data errors for a given error are considered to be independent from each other. i.e., positioning errors within this time may be considered to be correlated (i.e., dependent on each other). This can be applicable to one or more errors shown in Table 7.

Accordingly, the integrity service parameters may include: an integrity risk allocation minimum value, an integrity risk allocation maximum value, an integrity risk allocation value that is between the integrity risk allocation minimum value and the integrity risk allocation maximum value, average duration of the occurrence of the error, probability value that the error occurs, integrity correlation time, and/or a target integrity risk.

The location server may first determine if the UE has the required capability to exchange or transfer integrity service related information, the capability to determine error bounds for particular positioning errors, or the combination thereof. The location server (LMF) may use this capability information to trigger and initiate the request for integrity service and error bound information. The LMF may use LPP signalling such as RequestCapabilityInformation to request the UE for integrity service and error bound related information and the UE may use LPP ProvideCapabilityInformation to transmit the aforementioned capabilities in the response.

### Measurement Errors

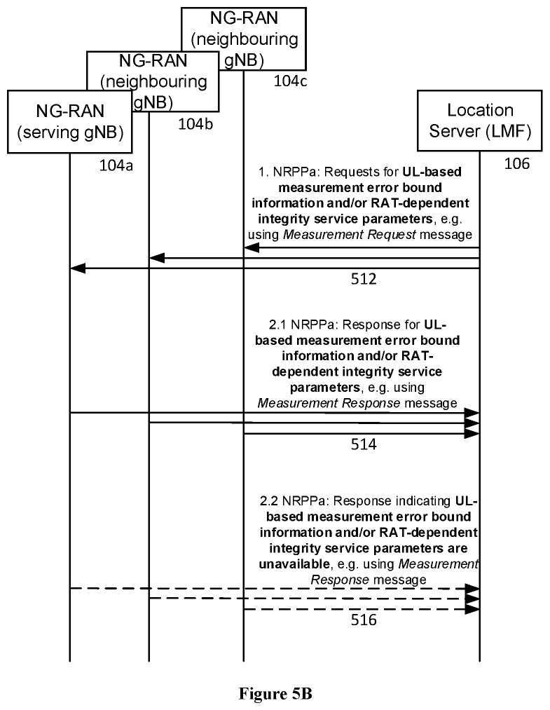

According to one aspect, in the case of LMF-based positioning integrity, the LMF may request DL-based measurement error bound information and integrity service parameters from the UE according to the desired positioning method and associated positioning measurement, e.g., DL RSTD, DL PRS RSRP/RSRPP, UE Rx-Tx time difference measurements. FIG. 5A is a schematic diagram illustrating an example of enabling collection of DL-based measurement error bound information and associated integrity service parameters via request/response signalling in accordance with some implementations of the present disclosure.

In the exemplary illustration of the signalling flow using LPP signalling shown in FIG. 5A, the steps for enabling the collection of DL-based measurement error bound information and RAT-dependent integrity service parameters for LMF-based integrity are detailed as follows.

The location server (LMF) 106 may first request the target-UE 102 to provide error bound information for each of the configured DL-based measurements according to A-1, A-3, and A-6 of 7, which include the mean, standard deviation, variance, or any other statistical parameters associated with the error distribution, and/or to provide RAT-dependent integrity service parameters, using LPP RequestLocationInformation message 502. That is, the LMF 106 may send a request message to the target-UE 102 for requesting collection of integrity information, where the integrity information includes integrity service parameters and error bound information associated with the measurement error (i.e., a type of positioning error). In an extended implementation, the LMF 106 may request the type of error distribution in addition to the associated error bound information, e.g., in the scenarios where the measurement error is characterized by more than one distribution in the case of LOS and/or NLOS measurements. In another extended implementation, the LMF 106 may request for the information whether the measurement error is associated with a LOS and/or NLOS measurement. This may be associated with a LOS/NLOS indicator, which may be a binary indicator such as [0 or 1] or a soft indicator such as [0, 0.1, 0.2, . . . , 0.9, 1]. In another implementation, the LMF may provide a time duration or time window during which the requested error bound information and integrity service parameters are evaluated. The integrity service parameters and measurement error bounds may be requested per positioning method. The request for integrity service parameters may include request for Integrity Risk information such as TIR, IRallocation bounds, or the like.

The target-UE 102 may positively or negatively respond to the LMF 106 depending on the availability of the requested integrity information.

The target-UE 102 may respond with the requested information, e.g., DL-based measurement error bound information and/or RAT-dependent integrity service parameters, according to the different described implementations, using LPP ProvideLocationInformation message 504, if the information is available. The target-UE 102 may compute the mean, standard deviation, variance, or any other statistical parameters of the error associated to the performed measurement together with the associated information to aid the computation of the error of the particular requested positioning measurement.

In the event that the measurement error bound information and/or associated integrity service parameters are unavailable, the target-UE 102 may report the unavailability of measurement error bound information, integrity service parameters, or the combination thereof, using LPP ProvideLocationInformation message 506.

The LMF 106 may determine an integrity of a positioning estimate according to the response message.

The measurement error may comprise error in measurement of: Downlink (DL) Reference Signal Time Difference (RSTD), Uplink (UL) Relative Time Of Arrival (RTOA), UL Angle-of-Arrival (AoA). 5G Node B (gNB) Receive Transmit (Rx-Tx) time difference measurements, UL Positioning Reference Signal (PRS) Reference Signal Received Power (RSRP), UL PRS Reference Signal Received Path Power (RSRPP), UE Rx-Tx time difference, DL PRS RSRP, and/or DL PRS RSRPP.

The above procedures may be enabled using existing signalling mechanisms as depicted in FIG. 5A. The following signalling extracts are used as exemplary illustrations of the reported integrity parameters based on each DL-based measurement report.

NR-DL-TDOA-SignalMeasurementInformation

-- ASN1START
NR-DL-TDOA-SignalMeasurementInformation-r16 ::= SEQUENCE {

| | |
|---|---|
| dl-PRS-ReferenceInfo-r16 | DL-PRS-ID-Info-r16, |
| nr-DL-TDOA-MeasList-r16 | NR-DL-TDOA-MeasList-r16, |

...
}
NR-DL-TDOA-MeasList-r16 ::= SEQUENCE (SIZE(1..nrMaxTRPs-r16)) OF NR-DL-TDCA-MeasElement-
r16
NR-DL-TDOA-MeasElement-r16 ::= SEQUENCE {

| | |
|---|---|
| dl-PRS-ID-r16 | INTEGER (0..255), |
| nr-PhysCellID-r16 | NR-PhysCellID-r16 |

OPTIONAL,

| | |
|---|---|
| nr-CellGlobalID-r16 | NCGI-r15 |

OPTIONAL,

| | |
|---|---|
| nr-ARFCN-r16 | ARFCN-ValueNR-r15 |

OPTIONAL,

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceSetID-r16 |

OPTIONAL,

| | |
|---|---|
| nr-TimeStamp-r16 | NR-TimeStamp-r16, |
| nr-RSTD-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

```
    ...
  },
```

| | |
|---|---|
| nr-AdditionalPatchList-r16 | NR-AdditionalPathList-r16 |

OPTIONAL,

| | |
|---|---|
| nr-TimingQuality-r16 | NR-TimingQuality-r16, |
| nr-DL-PRS-RSRP-Result-r16 | INTEGER (0..126) |

```
  OPTIONAL,
  nr-DL-TDOA-AdditionalMeasurements-r16
```

NR-DL-TDOA-AdditionalMeasurements-r16

```
  OPTIONAL,
  ...,
  [[
```

| | |
|---|---|
| nr-UE-Rx-TEG-ID-r17 | INTEGER (0..maxNumOfRxTEGs-1-r17) |

OPTIONAL,

| | |
|---|---|
| nr-DL-PRS-FirstPathRSRP-Result-r17 | INTEGER (0..126) |

OPTIONAL,

| | |
|---|---|
| nr-los-nlos-Indicator-r17 | CHOICE { |
| perTRP-r17 | LOS-NLOS-Indicator-r17, |
| perResource-r17 | LOS-NLOS-Indicator-r17 |

```
  }
  OPTIONAL,
```

| | |
|---|---|
| nr-AdditionalPathListExt-r17 | NR-AdditionalPathListExt-r17 |

```
  OPTIONAL,
  nr-DL-TDOA-AdditionalMeasurementsExt-r17
```

NR-DL-TDOA-AdditionalMeasurementsExt-r17

```
  OPTIONAL
  ]]
}
NR-DL-TDOA-AdditionalMeasurements-r16 ::= SEQUENCE (SIZE (1..3)) OF
```

NR-DL-TDOA-

AdditionalMeasurementElement-r16
NR-DL-TDOA-AdditionalMeasurementsExt-r17 ::= SEQUENCE (SIZE (1..maxAddMeasTDOA-r17)) OF

NR-DL-TDOA-

AdditionalMeasurementElement-r16
NR-DL-TDOA-AdditionalMeasurementElement-r16 ::= SEQUENCE {

| | |
|---|---|
| nr-DL-PRS-ResourceID-r16 | NR-DL-PRS-ResourceID-r16 |

OPTIONAL,

| | |
|---|---|
| nr-DL-PRS-ResourceSetID-r16 | NR-DL-PRS-ResourceID-r16 |

OPTIONAL,

| | |
|---|---|
| nr-TimeStamp-r16 | NR-TimeStamp-r16, |
| nr-RSTD-ResultDiff-r16 | CHOICE { |
| k0-r16 | INTEGER (0..8191), |
| k1-r16 | INTEGER (0..4095), |
| k2-r16 | INTEGER (0..2047), |
| k3-r16 | INTEGER (0..1023), |
| k4-r16 | INTEGER (0..511), |
| k5-r16 | INTEGER (0..255), |

```
    ...
  },
```

| | |
|---|---|
| nr-TimingQuality-r16 | NR-TimingQuality-r16, |
| nr-DL-PRS-RSRP-ResultDiff-r16 | INTEGER (0..61) |

OPTIONAL,

| | |
|---|---|
| nr-AdditionalPathList-r16 | NR-AdditionalPathList-r16 |

```
  OPTIONAL,
  ...,
  [[
```

| | |
|---|---|
| nr-UE-Rx-TEG-ID-r17 | INTEGER (0..maxNumOfRxTEGs-1-r17) |

```
  OPTIONAL,
  nr-DL-PRS-FirstPathRSRP-ResultDiff-r17
```

INTEGER (0..61)

```
  OPTIONAL,
  nr-los-nlos-IndicatorPerResource-r17
```

LOS-NLOS-Indicator-r17

OPTIONAL,

| | |
|---|---|
| nr-AdditionalPathListExt-r17 | NR-AdditionalPathListExt-r17 |

```
  OPTIONAL
  ]]
}
```

| | |
|---|---|
| DL-TDoA-IntegrityRSTDBounds ::= | SEQUENCE { |
| Distribution-Type | CHOICE{Normal, Uniform} |
| LOS-NLOS-MeasurementError | CHOICE{LOS, NLOS, LOS+NLOS} |
| RSTDMeasurementEvalTime | INTEGER (time units) |
| meanRSTD | INTEGER (0..255), |
| stdDevRSTD | INTEGER (0..255), |
| varRSTD | INTEGER (0..255), |

...
}
DL-TDoA-IntegrityServiceParameters::= SEQUENCE {

| | |
|---|---|
| Ir-RSTD-Minimum-r17 | INTEGER (0..255), |
| ir-RSTD-Maximum-r17 | INTEGER (0..255), |

...
}
-- ASN1STOP

Description of the fields in the NR-DL-TDOA-SignalMeasurementInformation is provided as follows in Table 8 for DL-TDoA-IntegrityRSTDBounds and in Table 9 for DL-TDoA-IntegrityServiceParameters.

TABLE 8
DL-TDoA-IntegrityRSTDBounds Fields
DL-TDoA-IntegrityRSTDBounds field descriptions

Distribution-Type
This field specifies the type Distribution model of the measurement
LOS-NLOS-MeaurementError
This field specifies whether the reported RSTD measurement(s) errors are LOS, NLOS, or
combination thereof.
RSTDMeasurementEvalTime
This field specifies the time duration over which the error was evaluated, which are specified in time
units, e.g. milliseconds, seconds
meanRSTD
This field specifies the Mean RSTD Measurement Error bound which is the mean value for an
overbounding model that bounds the residual measurement error.
The bound is meanRSTD + K * stdDevRSTD and shall be so that the probability of it to be exceeded
shall be lower than IR_{allocation} for irMinimum < IR_{allocation} < irMaximum, where K = normInv(IR_{allocation} / 2)
and irMinimum, irMaximum as provided in IE GNSS-Integrity-ServiceParameters.
This IR_{allocation} is a fraction of the Target Integrity Risk that represents the integrity risk budget
available.
Scale factor 0.005 m; range 0-1.275 m.
stdDevRSTD
This field specifies the Standard Deviation RSTD measurement Error bound which is the standard
deviation for an overbounding model that bounds the residual RSTD error.
Scale factor 0.005 m; range 0-1.275 m.
varRSTD
This field specifies the variance of the RSTD measurement Error.

TABLE 9
DL-TDoA-Integrity-ServiceParameters Fields
DL-TDoA-Integrity-ServiceParameters field descriptions

Ir-RSTD-Minimum
This field specifies the Minimum Integrity Risk (IR) which is the minimum IR for which the DL-TDoA
measurement error bounds provided in the DL-TDoA -IntegrityRSTDBounds IE is valid. In another
implementation, this parameter may be signalled as a common parameter applicable to all UE
positioning measurements including DL-RSTD, DL-RSRP, DL-RSRPP, UE Rx-Tx time difference
measurements or the like to enhance signalling efficiency and avoid signalling overhead of reporting
per positioning method and measurement.
The IR is calculated by P = 10^{-0.04n} where n is the value of irMinimum and the range is 10^{-10.2} to 1.
Ir-RSTD-Maximum
This field specifies the Maximum Integrity Risk (IR) which is the maximum IR for which the DL-TDoA
measurement error bounds provided in the DL-TDoA -IntegrityRSTDBounds IE is valid. In another
implementation, this parameter may be signalled as a common parameter applicable to all UE
positioning measurements including DL-RSTD, DL-RSRP, DL-RSRPP, UE Rx-Tx time difference
measurements or the like to enhance signalling efficiency and avoid signalling overhead of reporting
per positioning method and measurement.
The IR is calculated by P = 10^{-0.04n} where n is the value of irMaximum and the range is 10^{-10.2} to 1.

The above measurement error bounds and integrity service parameters may be extended to DL-PRS RSRP, DL-PRS RSRPP, UE Rx-Tx time difference as well as other positioning measurements, which are reported to the LMF. In addition, the above measurement error bounds and integrity service parameters are applicable to a single error distribution, but in some implementations, multiple sets of these parameters may be associated to each probability error distribution.

In another implementation, in the case of UE-based integrity, the DL-TDoA-Integrity-ServiceParameters and DL-AoD-Integrity-ServiceParameters may be signalled to the UE via broadcast signalling, e.g., using new positioning SIB(s) to enable calculation of the positioning integrity with UE-based positioning methods. In a further implementation, the aforementioned integrity service parameters may be signalled using UE-specific signalling, e.g., LPP ProvideAssistanceData.

According to a further aspect, the above described measurement error bounds and integrity service parameters may be reported from the NG-RAN node to the LMF using NRPPa signalling, e.g., using the Measurement Response message.

In the case of LMF-based positioning integrity, the LMF may request UL-based measurement error bound information and integrity service parameters from the NG-RAN node, e.g., serving gNB, neighbouring gNB(s) according to the desired positioning method and associated positioning measurement, e.g., UL-RTOA, UL-AoA, etc. FIG. 5B is a schematic diagram illustrating an example of enabling collection of UL-based measurement error bound information and associated integrity service parameters via request/response signalling in accordance with some implementations of the present disclosure.

In the exemplary illustration of the signalling flow using NRPPa signalling shown in FIG. 5B, the steps for enabling the collection of UL-based measurement error bound information and RAT-dependent integrity service parameters for LMF-based integrity are detailed as follows.

The LMF 106 may request the NG-RAN node, e.g., serving gNB 104a, neighbouring gNB(s) 104b, 104c, to provide error bound information for each of the configured UL-based measurements according to A-2, A-4, and A-5 of Table 7, which include the mean, standard deviation, variance, or any other statistical parameters associated with the error distribution, and/or to provide RAT-dependent integrity service parameters, using NRPPa Measurement Request message 512. In an extended implementation, the LMF 106 may request the type of error distribution in addition to the associated error bound information. e.g., in the scenarios where the measurement error is characterized by more than one distribution in the case of LOS and/or NLOS measurements. In another extended implementation, the LMF 106 may request for the information whether the measurement error is associated with a LOS and/or NLOS measurement. This may be associated with a LOS/NLOS indicator, which may be a binary indicator such as [0 or 1] or a soft indicator such as [0, 0.1, 0.2, . . . , 0.9, 1]. In another implementation, the LMF may provide time duration or time window during which the requested error bound information and integrity service parameters are evaluated. The integrity service parameters and measurement error may be requested per positioning method, e.g., UL-TDoA, UL-AoA, Multi-RTT. The request for integrity service parameters may include request for Integrity Risk information such as TIR, IRallocation bounds, or the like.

The NG-RAN node may positively or negatively respond to the LMF 106 depending on the availability of the requested integrity information.

The NG-RAN node may respond with the requested information, e.g., UL-based measurement error bound information and/or RAT-dependent integrity service parameters, according to the different described implementations using NRPPa Measurement Response message 514, if the information is available. The NG-RAN node may compute the mean, standard deviation, variance, or any other statistical parameters of the error associated to the performed measurement together with the associated information to aid the computation of the integrity of the particular requested positioning measurement.

In the event that the measurement error bound information and/or associated integrity service parameters are unavailable, the NG-RAN node may report the unavailability of measurement error bound information, integrity service parameters, or the combination thereof, using NRPPa Measurement Response message 516.

The above integrity request/response signalling may be achieved using signalling interface between a NG-RAN node and LMF. e.g., using NRPPa Measurement Request and Response messages.

### Assistance Data Errors

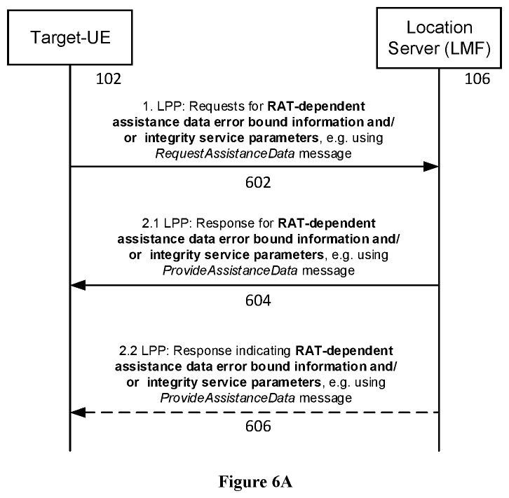

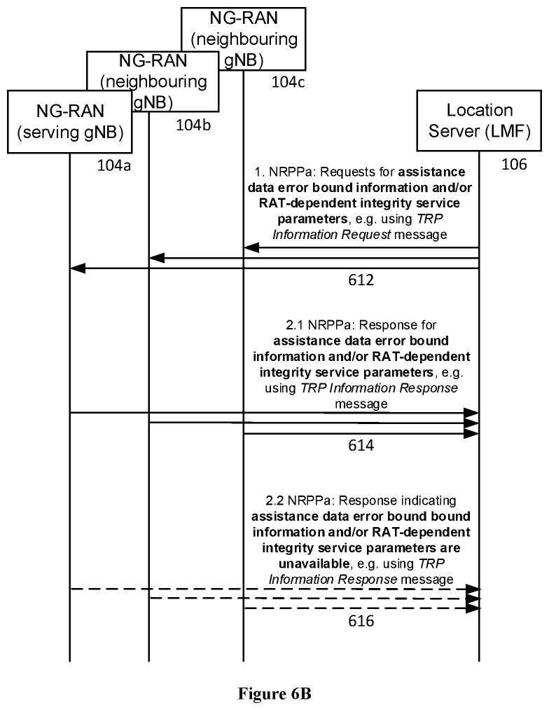

According to one aspect, in the case of UE-based positioning integrity, the UE may request for the assistance data error bound information and the LMF may respond with the requested assistance data error bound information and/or related integrity service parameters to the UE according to the desired positioning method. FIG. 6A is a schematic diagram illustrating an example of enabling collection of assistance data error bound information and associated integrity service parameters via LMF-UE request/response signalling in accordance with some implementations of the present disclosure.

In the exemplary illustration of the signalling flow using LPP signalling shown in FIG. 6A, the steps for enabling the collection of assistance data error bound information and RAT-dependent integrity service for UE-based integrity are detailed as follows.

The UE 102 may request the LMF 106 to provide error bound information for each of the configured DL-based measurements according to B-3, B-4, B-5, and B-6 of Table 7, which include the mean, standard deviation, variance, or any other statistical parameters associated with the assistance data error distribution, and/or to provide RAT-dependent integrity service parameters, using LPP RequestAssistanceData message 602. That is, the UE 102 may send a request message to the LMF 106 for requesting collection of integrity information, where the integrity information includes integrity service parameters and error bound information associated with the assistance data error (i.e., a type of positioning error). In an extended implementation, the UE 102 may request the type of error distribution in addition to the associated error bound information, e.g., in the scenarios where the assistance data error is characterized by more than one distribution based on the type of assistance data, e.g., TRP Location may be assumed to normal or uniformly distributed. In another implementation, the UE 102 may provide a time duration/window over which the requested assistance data error bound information and integrity service parameters are evaluated. The integrity service parameters and assistance data error bounds may be requested per positioning method, e.g., DL-TDoA and/or DL-AoD. The request for integrity service parameters may include the request for Integrity Risk information such as TIR, IRallocation bounds, or the like.

The LMF 106 may positively or negatively respond to the UE 102 depending on the availability of the requested integrity information.

The LMF 106 may respond with the requested information, e.g., RAT-dependent assistance data bound information and/or integrity service parameters, according to the different described implementations, using LPP ProvideAssistanceData message 604, if the information is available. The LMF 106 may compute the mean, standard deviation, variance, or any other statistical parameters of the error associated to the assistance data together with the associated information to aid the computation of the error of the particular requested positioning measurement.

In the event that the assistance data error bound information and/or associated integrity service parameters are unavailable, the LMF 106 may indicate the unavailability of assistance data error bound information, integrity service parameters, or the combination thereof, using LPP ProvideAssistanceData message 606.

The assistance data error for UE-based positioning integrity may further comprise the TRP location, Inter-TRP synchronization information (RTD Information), SFN initialization time, TRP beam information including beam antenna information (such as Antenna Reference Point (ARP) Location Information, DL PRS Beam information, and/or DL PRS beam antenna information), expected RSTD, confidence intervals associated to TRP Location and expected RSTD, and/or the like.

According to a further aspect, in the case of LMF-based positioning integrity, the LMF may request assistance data error bound information and integrity service parameters from the NG-RAN node, e.g., serving gNB, neighbouring gNB(s) according to the desired positioning method, e.g., TRP Location, ARP Location, etc. FIG. 6B is a schematic diagram illustrating an example of enabling collection of assistance data error bound information and associated integrity service parameters via LMF-NG-RAN node request/response signalling in accordance with some implementations of the present disclosure

In the exemplary illustration of the signalling flow using NRPPa signalling shown in FIG. 6B, the steps for enabling the collection of assistance data error bound information and RAT-dependent integrity service parameters for LMF-based integrity are detailed as follows.

The LMF 106 may request the NG-RAN node, e.g., serving gNB 104a, neighbouring gNB(s) 104b, 104c, to provide error bound information for each of the configured UL-based measurements according to A-7 to A-16 of Table 7, which include the mean, standard deviation, variance, or any other statistical parameters associated with the assistance data error distribution, and/or to provide RAT-dependent integrity service parameters, using NRPPa TRP Information Request message 612. In an extended implementation, the LMF 106 may request the type of error distribution in addition to the associated error bound information, e.g., in the scenarios where a specific assistance data error is characterized by more than one distribution, for example, the TRP Location may be characterized as Uniform or normal distribution. The error bounds and integrity service parameters would then have to be provided per error distribution model associated to that specific assistance data.

The NG-RAN node may positively or negatively respond depending on the availability of the requested integrity information.

The NG-RAN node may respond with the requested information, e.g., assistance data error bound information and/or RAT-dependent integrity service parameters, according to the aforementioned implementations, using NRPPa TRP Information Response message 614, if the information is available. The NG-RAN node may compute the mean, standard deviation, variance, or any other statistical parameters of the error associated to the requested assistance data together with the associated information to aid the computation of the integrity of the particular requested positioning assistance data error.

In the event that the assistance data error bound information and/or associated integrity service parameters are unavailable, the NG-RAN node may report the unavailability of assistance data error bound information, integrity service parameters, or the combination thereof, using NRPPa TRP Information Response message 616.

The above integrity request/response signalling may be achieved using signalling interface between a NG-RAN node and LMF, e.g., using NRPPa TRP Information Request and Response messages.

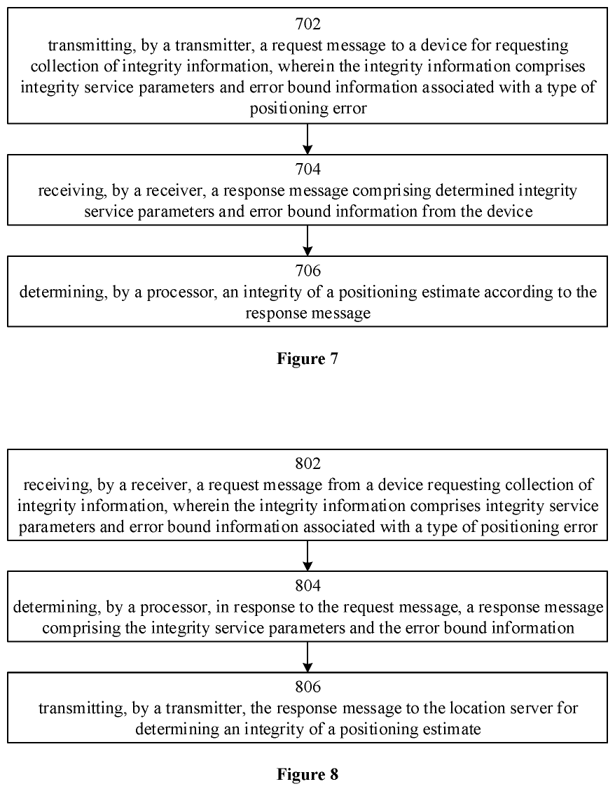

FIG. 7 is a flow chart illustrating steps of determining integrity of positioning estimates by UE 200 or LMF 106 in accordance with some implementations of the present disclosure.

At step 702, the transmitter 212 of UE 200 or the transmitter of the LMF 106 transmits a request message to a device for requesting collection of integrity information, wherein the integrity information comprises integrity service parameters and error bound information associated with a type of positioning error.

At step 704, the receiver 214 of UE 200 or the receiver of the LMF 106 receives a response message comprising determined integrity service parameters and error bound information from the device.

At step 706, the processor 202 of UE 200 or the processor of the LMF 106 determines an integrity of a positioning estimate according to the response message.

In some examples, the LMF 106 may transmit the request message; and the device may be any one or more of positioning participating devices, or devices that transmit and/or receive positioning signals, e.g., gNB 104. TRP 104a, or UE 102. The request message may be a RequestLocationInformation message 502, a Measurement Request message 512, or a TRP Information Request message 612, and the response message may be a ProvideLocationInformation message 504, a Measurement Response message 514, or a TRP Information Response message 614.

In some other examples, the UE 102 may transmit the request message; and the device may be the LMF 106. The request message may be a RequestAssistanceData message 602, and the response message may be a ProvideAssistanceData message 604.

The request message may be related to one positioning method, a plurality of positioning methods, or all available positioning methods.

FIG. 8 is a flow chart illustrating steps of determining integrity of positioning estimates by UE 200 or gNB 300 in accordance with some implementations of the present disclosure.

At step 802, the receiver 214 of UE 200 or the receiver 314 of gNB 300 receives a request message from a device requesting collection of integrity information, wherein the integrity information comprises integrity service parameters and error bound information associated with a type of positioning error.

At step 804, the processor 202 of UE 200 or the processor 302 of gNB 300 determines, in response to the request message, a response message comprising the integrity service parameters and the error bound information.

At step 806, the transmitter 212 of UE 200 or the transmitter 312 of gNB 300 transmits the response message to the location server for determining an integrity of a positioning estimate.

In one aspect, some items as examples of the disclosure concerning UE may be summarized as follows:
1. An apparatus, comprising:
a transmitter that transmits a request message to a device for requesting collection of integrity information, wherein the integrity information comprises integrity service parameters and error bound information associated with a type of positioning error;
a receiver that receives a response message comprising determined integrity service parameters and error bound information from the device; and
a processor that determines an integrity of a positioning estimate according to the response message.
2. The apparatus according to item 1, wherein the integrity information relates to Radio Access Technology (RAT)-dependent positioning methods; and the integrity service parameters comprise:
an integrity risk allocation minimum value,
an integrity risk allocation maximum value,
an integrity risk allocation value that is between the integrity risk allocation minimum value and the integrity risk allocation maximum value,
average duration of the occurrence of the error,
probability value that the error occurs.
integrity correlation time, and/or
a target integrity risk.
3. The apparatus according to item 1, wherein the error bound information comprises: type of error distribution, mean, standard deviation, and/or variance, associated with the error distribution.
4. The apparatus according to item 1, wherein the type of positioning error comprises: measurement error, and/or assistance data error.
5. The apparatus according to item 4, wherein the measurement error comprises error in measurement of: Downlink (DL) Reference Signal Time Difference (RSTD), Uplink (UL) Relative Time Of Arrival (RTOA), UL Angle-of-Arrival (AoA), 5G Node B (gNB) Receive Transmit (Rx-Tx) time difference measurements, UL Positioning Reference Signal (PRS) Reference Signal Received Power (RSRP). UL PRS Reference Signal Received Path Power (RSRPP), UE Rx-Tx time difference, DL PRS RSRP, and/or DL PRS RSRPP.
6. The apparatus according to item 4, wherein the measurement error is associated with Line-of-Sight (LOS) or Non-Line-of-Sight (NLOS) measurement further comprising a hard or soft value indication.
7. The apparatus according to item 4, wherein the assistance data error comprises error in: Transmission Reception Point (TRP) Location, System Frame Number (SFN) Initialization time, Inter-TRP synchronization information. Antenna Reference Point (ARP) Location Information, DL PRS Beam information, and/or DL PRS beam antenna information.
8. The apparatus according to item 1, wherein the request message is related to one positioning method.
9. The apparatus according to item 1, wherein the request message is related to a plurality of positioning methods.
10. The apparatus according to item 1, wherein the receiver receives an indication related to the unavailability of the integrity service parameters and the error bound information associated with the type of positioning error.
11. The apparatus according to item 1, wherein the positioning methods comprise: DL-Time Difference of Arrival (TDoA) positioning method, DL Angle of Departure (AoD) positioning method, Multiple-Round Trip Time (Multi-RTT) positioning method, Enhanced Cell ID (CID) positioning method, UL TDOA positioning method, and/or UL AoA positioning method.
12. The apparatus according to item 1, wherein the request message is transmitted upon reception of a capability information requirement associated with a UE.
13. The apparatus according to item 1, wherein the messages are exchanged via Long Term Evolution Positioning Protocol (LPP) signalling, and/or NR Positioning Protocol Annex (NRPPa) signalling.

In another aspect, some items as examples of the disclosure concerning gNB may be summarized as follows:
14. An apparatus, comprising:
a receiver that receives a request message from a device requesting collection of integrity information, wherein the integrity information comprises integrity service parameters and error bound information associated with a type of positioning error;
a processor that determines, in response to the request message, a response message comprising the integrity service parameters and the error bound information; and
a transmitter that transmits the response message to the location server for determining an integrity of a positioning estimate.
15. The apparatus according to item 14, wherein the integrity information relates to Radio Access Technology (RAT)-dependent positioning methods; and the integrity service parameters comprise:
an integrity risk allocation minimum value,
an integrity risk allocation maximum value,
an integrity risk allocation value that is between the integrity risk allocation minimum value and the integrity risk allocation maximum value,
average duration of the occurrence of the error,
probability value that the error occurs.
integrity correlation time, and/or
a target integrity risk.
16. The apparatus according to item 14, wherein the error bound information comprises: type of error distribution, mean, standard deviation, and/or variance, associated with the error distribution.
17. The apparatus according to item 14, wherein the type of positioning error comprises: measurement error, and/or assistance data error.
18. The apparatus according to item 17, wherein the measurement error comprises error in measurement of: Downlink (DL) Reference Signal Time Difference (RSTD), Uplink (UL) Relative Time Of Arrival (RTOA), UL Angle-of-Arrival (AoA), 5G Node B (gNB) Receive Transmit (Rx-Tx) time difference measurements, UL Positioning Reference Signal (PRS) Reference Signal Received Power (RSRP), UL PRS Reference Signal Received Path Power (RSRPP), UE Rx-Tx time difference, DL PRS RSRP, and/or DL PRS RSRPP.
19. The apparatus according to item 17, wherein the measurement error is associated with Line-of-Sight (LOS) or Non-Line-of-Sight (NLOS) measurement further comprising a hard or soft value indication.
20. The apparatus according to item 17, wherein the assistance data error comprises error in: Transmission Reception Point (TRP) Location, System Frame Number (SFN) Initialization time, Inter-TRP synchronization information, Antenna Reference Point (ARP) Location Information, DL PRS Beam information, and/or DL PRS beam antenna information.
21. The apparatus according to item 14, wherein the request message is related to one positioning method.
22. The apparatus according to item 14, wherein the request message is related to a plurality of positioning methods.
23. The apparatus according to item 14, wherein the transmitter transmits an indication related to the unavailability of the integrity service parameters and the error bound information associated with the type of positioning error.
24. The apparatus according to item 14, wherein the positioning methods comprise: DL-Time Difference of Arrival (TDoA) positioning method, DL Angle of Departure (AoD) positioning method, Multiple-Round Trip Time (Multi-RTT) positioning method, Enhanced Cell ID (CID) positioning method, UL TDOA positioning method, and/or UL AoA positioning method.
25. The apparatus according to item 14, wherein the request message is transmitted by the device upon reception of a capability information requirement associated with a UE.
26. The apparatus according to item 14, wherein the messages are exchanged via Long Term Evolution Positioning Protocol (LPP) signalling, and/or NR Positioning Protocol Annex (NRPPa) signalling.

In a further aspect, some items as examples of the disclosure concerning a method of UE may be summarized as follows:
27. A method, comprising:
transmitting, by a transmitter, a request message to a device for requesting collection of integrity information, wherein the integrity information comprises integrity service parameters and error bound information associated with a type of positioning error;
receiving, by a receiver, a response message comprising determined integrity service parameters and error bound information from the device; and
determining, by a processor, an integrity of a positioning estimate according to the response message.
28. The method according to item 27, wherein the integrity information relates to Radio Access Technology (RAT)-dependent positioning methods; and the integrity service parameters comprise:
an integrity risk allocation minimum value,
an integrity risk allocation maximum value,
an integrity risk allocation value that is between the integrity risk allocation minimum value and the integrity risk allocation maximum value,
average duration of the occurrence of the error,
probability value that the error occurs.
integrity correlation time, and/or
a target integrity risk.
29. The method according to item 27, wherein the error bound information comprises: type of error distribution, mean, standard deviation, and/or variance, associated with the error distribution.
30. The method according to item 27, wherein the type of positioning error comprises: measurement error, and/or assistance data error.
31. The method according to item 30, wherein the measurement error comprises error in measurement of: Downlink (DL) Reference Signal Time Difference (RSTD), Uplink (UL) Relative Time Of Arrival (RTOA), UL Angle-of-Arrival (AoA), 5G Node B (gNB) Receive Transmit (Rx-Tx) time difference measurements, UL Positioning Reference Signal (PRS) Reference Signal Received Power (RSRP). UL PRS Reference Signal Received Path Power (RSRPP), UE Rx-Tx time difference, DL PRS RSRP, and/or DL PRS RSRPP.
32. The method according to item 30, wherein the measurement error is associated with Line-of-Sight (LOS) or Non-Line-of-Sight (NLOS) measurement further comprising a hard or soft value indication.
33. The method according to item 30, wherein the assistance data error comprises error in: Transmission Reception Point (TRP) Location, System Frame Number (SFN) Initialization time, Inter-TRP synchronization information, Antenna Reference Point (ARP) Location Information, DL PRS Beam information, and/or DL PRS beam antenna information.
34. The method according to item 27, wherein the request message is related to one positioning method.
35. The method according to item 27, wherein the request message is related to a plurality of positioning methods.
36. The method according to item 27, wherein the receiver receives an indication related to the unavailability of the integrity service parameters and the error bound information associated with the type of positioning error.
37. The method according to item 27, wherein the positioning methods comprise: DL-Time Difference of Arrival (TDoA) positioning method, DL Angle of Departure (AoD) positioning method, Multiple-Round Trip Time (Multi-RTT) positioning method, Enhanced Cell ID (CID) positioning method, UL TDOA positioning method, and/or UL AoA positioning method.
38. The method according to item 27, wherein the request message is transmitted upon reception of a capability information requirement associated with a UE.
39. The method according to item 27, wherein the messages are exchanged via Long Term Evolution Positioning Protocol (LPP) signalling, and/or NR Positioning Protocol Annex (NRPPa) signalling.

In a yet further aspect, some items as examples of the disclosure concerning a method of gNB may be summarized as follows:
40. A method, comprising:
receiving, by a receiver, a request message from a device requesting collection of integrity information, wherein the integrity information comprises integrity service parameters and error bound information associated with a type of positioning error;
determining, by a processor, in response to the request message, a response message comprising the integrity service parameters and the error bound information; and
transmitting, by a transmitter, the response message to the location server for determining an integrity of a positioning estimate.
41. The method according to item 40, wherein the integrity information relates to Radio Access Technology (RAT)-dependent positioning methods; and the integrity service parameters comprise:
an integrity risk allocation minimum value,
an integrity risk allocation maximum value,
an integrity risk allocation value that is between the integrity risk allocation minimum value and the integrity risk allocation maximum value.
average duration of the occurrence of the error,
probability value that the error occurs,
integrity correlation time, and/or
a target integrity risk.
42. The method according to item 40, wherein the error bound information comprises: type of error distribution, mean, standard deviation, and/or variance, associated with the error distribution.
43. The method according to item 40, wherein the type of positioning error comprises: measurement error, and/or assistance data error.
44. The method according to item 43, wherein the measurement error comprises error in measurement of: Downlink (DL) Reference Signal Time Difference (RSTD), Uplink (UL) Relative Time Of Arrival (RTOA), UL Angle-of-Arrival (AoA), 5G Node B (gNB) Receive Transmit (Rx-Tx) time difference measurements, UL Positioning Reference Signal (PRS) Reference Signal Received Power (RSRP). UL PRS Reference Signal Received Path Power (RSRPP), UE Rx-Tx time difference, DL PRS RSRP, and/or DL PRS RSRPP.
45. The method according to item 43, wherein the measurement error is associated with Line-of-Sight (LOS) or Non-Line-of-Sight (NLOS) measurement further comprising a hard or soft value indication.
46. The method according to item 43, wherein the assistance data error comprises error in: Transmission Reception Point (TRP) Location, System Frame Number (SFN) Initialization time, Inter-TRP synchronization information, Antenna Reference Point (ARP) Location Information, DL PRS Beam information, and/or DL PRS beam antenna information.
47. The method according to item 40, wherein the request message is related to one positioning method.
48. The method according to item 40, wherein the request message is related to a plurality of positioning methods.
49. The method according to item 40, wherein the transmitter transmits an indication related to the unavailability of the integrity service parameters and the error bound information associated with the type of positioning error,
50. The method according to item 40, wherein the positioning methods comprise: DL-Time Difference of Arrival (TDoA) positioning method, DL Angle of Departure (AoD) positioning method, Multiple-Round Trip Time (Multi-RTT) positioning method, Enhanced Cell ID (CID) positioning method, UL TDOA positioning method, and/or UL AoA positioning method.
51. The method according to item 40, wherein the request message is transmitted by the device upon reception of a capability information requirement associated with a UE.
52. The method according to item 40, wherein the messages are exchanged via Long Term Evolution Positioning Protocol (LPP) signalling, and/or NR Positioning Protocol Annex (NRPPa) signalling.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. An apparatus for wireless communication, configured to:
transmit a request message for requesting collection of integrity information, wherein the integrity information comprises one or more of integrity service parameters or error bound information associated with a type of positioning error;
receive a response message comprising one or more of the integrity service parameters or error bound information; and
determine an integrity of a positioning estimate according to the response message.

2. The apparatus of claim 1, wherein the integrity service parameters include one or more of an integrity risk allocation minimum value, an integrity risk allocation maximum value, an integrity risk allocation value between the integrity risk allocation minimum value and the integrity risk allocation maximum value, an integrity correlation time, or a target integrity risk.

3. The apparatus of claim 1, wherein the error bound information indicates one or more of a type of error distribution, a mean associated with the error distribution, a standard deviation associated with the error distribution, or a variance, associated with the error distribution.

4. The apparatus of claim 1, wherein the type of positioning error includes a measurement error or assistance data error.

5. The apparatus of claim 4, wherein the measurement error comprises one or more of: downlink (DL) reference signal time difference (RSTD), uplink (UL) relative time of arrival (RTOA), UL angle-of-arrival (AoA), receive-transmit (Rx-Tx) time difference measurements, UL positioning reference signal (PRS) reference signal received power (RSRP), UL PRS reference signal received path power (RSRPP), UE Rx-Tx time difference, DL PRS RSRP, or DL PRS RSRPP.

6. (canceled)

7. The apparatus of claim 4, wherein the assistance data error comprises error in one or more of: transmission reception point (TRP) location, inter-TRP synchronization information, antenna reference point (ARP) location information, DL PRS beam information, or DL PRS beam antenna information.

8. (canceled)

9. (canceled)

10. The apparatus of claim 1, wherein the apparatus is configured to receive an indication related to unavailability of one or more of the integrity service parameters or the error bound information associated with the type of positioning error.

11. (canceled)

12. The apparatus of claim 1, wherein to transmit the request message, the apparatus is configured to transmit the request message upon reception of a capability information requirement associated with a UE.

13. The apparatus of claim 1, wherein the messages are exchanged via one or more of long term evolution positioning protocol (LPP) signaling or new radio positioning protocol annex (NRPPa) signaling.

14. An apparatus for wireless communication, configured to:
receive a request message requesting collection of integrity information, wherein the integrity information comprises one or more of integrity service parameters or error bound information associated with a type of positioning error;
determine, in response to the request message, a response message comprising one or more of the integrity service parameters or the error bound information; and
transmit the response message comprising one or more of the integrity service parameters or error bound information.

15. A method for wireless communication, the method comprising:
transmitting a request message for requesting collection of integrity information, wherein the integrity information comprises one or more of integrity service parameters or error bound information associated with a type of positioning error;
receiving a response message comprising one or more of the integrity service parameters or error bound information; and
determining an integrity of a positioning estimate according to the response message.

16. The method of claim 15, wherein the integrity service parameters include one or more of an integrity risk allocation minimum value, an integrity risk allocation maximum value, an integrity risk allocation value between the integrity risk allocation minimum value and the integrity risk allocation maximum value, an integrity correlation time, or a target integrity risk.

17. The method of claim 15, wherein the error bound information indicates one or more of a type of error distribution, a mean associated with the error distribution, a standard deviation associated with the error distribution, or a variance associated with the error distribution.

18. The method of claim 15, wherein the type of positioning error includes a measurement error or assistance data error.

19. The method of claim 18, wherein the measurement error comprises one or more of: downlink (DL) reference signal time difference (RSTD), uplink (UL) relative time of arrival (RTOA), UL angle-of-arrival (AoA), receive-transmit (Rx-Tx) time difference measurements, UL positioning reference signal (PRS) reference signal received power (RSRP), UL PRS reference signal received path power (RSRPP), UE Rx-Tx time difference, DL PRS RSRP, or DL PRS RSRPP.

20. A method for wireless communication, the method comprising:
receiving a request message requesting collection of integrity information, wherein the integrity information comprises one or more of integrity service parameters or error bound information associated with a type of positioning error;
determining, in response to the request message, a response message comprising one or more of the integrity service parameters or the error bound information; and
transmitting the response message comprising one or more of the integrity service parameters or error bound information.

21. The apparatus of claim 14, wherein the integrity service parameters include one or more of an integrity risk allocation minimum value, an integrity risk allocation maximum value, an integrity risk allocation value between the integrity risk allocation minimum value and the integrity risk allocation maximum value, an integrity correlation time, or a target integrity risk.

22. The apparatus of claim 14, wherein the error bound information indicates one or more of a type of error distribution, a mean associated with the error distribution, a standard deviation associated with the error distribution, or a variance associated with the error distribution.

23. The apparatus of claim 14, wherein the type of positioning error includes a measurement error or assistance data error.

24. The apparatus of claim 23, wherein the measurement error comprises one or more of: downlink (DL) reference signal time difference (RSTD), uplink (UL) relative time of arrival (RTOA), UL angle-of-arrival (AoA), receive-transmit (Rx-Tx) time difference measurements, UL positioning reference signal (PRS) reference signal received power (RSRP), UL PRS reference signal received path power (RSRPP), UE Rx-Tx time difference, DL PRS RSRP, or DL PRS RSRPP.
